(19) United States
(12) Patent Application Publication
(10) Pub. No.: US 2020/0023931 A1
(43) Pub. Date: Jan. 23, 2020

(54) Control Lever Unit for Azimuth Thruster

(71) Applicant: Caterpillar Propulsion Production AB, Öckerö (SE)

(72) Inventor: Adnan Kadribasic, Öckerö (GB)

(73) Assignee: Caterpillar Propulsion Production AB, Öckerö (SE)

(21) Appl. No.: 16/465,627

(22) PCT Filed: Dec. 11, 2017
(86) PCT No.: PCT/EP2017/082295

§ 371 Date: May 31, 2019

(30) Foreign Application Priority Data
Dec. 14, 2016 (EP) 16204135.4

(51) Int. Cl. B63H 21/21; G05G 1/04; G05G 5/04

(52) U.S. Cl. CPC B63H 21/213; G05G 5/04; G05G 1/04

(57) ABSTRACT

The present disclosure relates to a control lever unit for an azimuth thruster. The control lever unit comprises a base plate, a main body rotatably connected to the base plate, and a handle movably connected to the main body. The handle includes a first handle portion extending away from the main body, and a second handle portion extending as a protrusion away from the first handle portion. The two handle portions may visually and haptically indicate the direction of thrust of the azimuth thruster to the operator.

### TECHNICAL FIELD

The present disclosure relates to a control lever unit for an azimuth thruster.

### BACKGROUND

Azimuth thrusters are commonly used as propulsion devices for marine vessels. Azimuth thrusters include propellers for generating a thrust force for propelling the vessel. For maneuvering the vessel, azimuth thrusters are rotatable about a substantially vertical axis to adapt a rotary position of the azimuth thruster, and thus, a direction of thrust of the azimuth thruster.

For adjusting an operation of the azimuth thruster, a control lever unit may be provided on a bridge of the marine vessel. Depending on the configuration of the azimuth thruster, the control lever unit may be configured to adjust a speed of the propeller, the rotary position of the azimuth thruster about the vertical axis, a pitch angle of the propeller blades, etc.

The present disclosure is directed, at least in part, to improving or overcoming one or more aspects of prior systems.

### SUMMARY OF THE DISCLOSURE

In one aspect, the present disclosure relates to a control lever unit for an azimuth thruster. The control lever unit comprises a base plate defining a central axis normal to the base plate, and a main body rotatably connected to the base plate to be rotatable relative to the base plate about the central axis. The control lever unit further comprises a handle movably connected to the main body. The handle includes a first handle portion extending away from the main body, and a second handle portion extending as a protrusion away from the first handle portion.

In another aspect, a control lever unit for an azimuth thruster is disclosed. The control lever unit includes a base plate defining a central axis normal to the base plate. The control lever unit further includes a main body rotatably connected to the base plate to be rotatable relative to the base plate about the central axis. The control lever unit further includes a handle movably connected to the main body, and a pedestal interconnected between the main body and the base plate to be rotatable together with the main body about the central axis relative to the base plate.

In some embodiments of the above aspect, the pedestal includes a circumferential face extending about the central axis, and/or a light source configured to generate a light beam.

In some embodiments of the above aspect, the circumferential face has a plurality of indications, for example recesses and/or protrusions, arranged about the circumferential face of the pedestal.

In some embodiments of the above aspect, the circumferential face extends parallel to the central axis.

In yet another aspect, a control lever unit for an azimuth thruster is disclosed. The control lever unit includes a base plate defining a central axis normal to the base plate. The control lever unit further includes a main body rotatably connected to the base plate to be rotatable relative to the base plate about the central axis. The control lever unit further includes a handle movably connected to the main body. The handle is movable from a first end handle position through an intermediate handle position to a second end handle position. The control lever unit further comprises a button being movable between a first button position and a second button position. In the first button position, the handle is free to move between the first end handle position and the intermediate handle position and locked from moving between the intermediate handle position and the second end handle position. In the second button position, the handle is free to move at least between the intermediate handle position and the second end handle position.

In some embodiments of the above aspect, the button mechanically locks the handle from moving between the intermediate handle position and the second end handle position in the first button position, and/or the button is biased in the first button position.

In some embodiments of the above aspect, the main body includes a handle guide configured to receive the handle for guiding the handle, and the button is disposed in the handle guide.

In some embodiments of the above aspect, the button blocks the handle from moving between the intermediate handle position and the second end handle position in the first button position, and enables the handle to move between the intermediate handle position and the second end handle position in the second button position.

In some embodiments of the above aspect, the handle is configured to slide over the button in the second button position.

Other features and aspects of this disclosure will be apparent from the following description and the accompanying drawings.

### BRIEF DESCRIPTION OF THE DRAWINGS

The accompanying drawings, which are incorporated herein and constitute a part of the specification, illustrate exemplary embodiments of the disclosure and, together with the description, serve to explain the principles of the disclosure. In the drawings:

FIG. 1A shows a schematic side view of an azimuth thruster;

FIG. 1B shows a schematic front view of an azimuth thruster;

FIG. 2 shows an isometric view of an exemplary control lever unit for an azimuth thruster according to the present disclosure;

FIG. 3 shows a side view of the exemplary control lever unit of FIG. 2;

FIG. 4 shows a front view of the exemplary control lever unit of FIGS. 2 and 3; and

FIG. 5 shows a rear view of the exemplary control lever unit of FIGS. 2 to 4.

### DETAILED DESCRIPTION

The following is a detailed description of exemplary embodiments of the present disclosure. The exemplary embodiments described therein and illustrated in the drawings are intended to teach the principles of the present disclosure, enabling those of ordinary skill in the art to implement and use the present disclosure in many different environments and for many different applications. Therefore, the exemplary embodiments are not intended to be, and should not be considered as, a limiting description of the scope of patent protection. Rather, the scope of patent protection shall be defined by the appended claims.

The present disclosure is based in part on the realization that a handle of a control lever unit for an azimuth thruster can be used as a suitable visual and haptic indication of the rotary position of the azimuth thruster, that is, a direction of thrust as produced by the azimuth thruster. For this reason, the handle includes two handle portions arranged and configured to indicate the direction of thrust to the operator.

The present disclosure is further based in part on the realization that operators may desire to adjust the handle of the handle control lever unit in a quick and easy manner, for example by using a thumb of the operator's hand only. Accordingly, herein it is suggested to include a recess in the handle. The recess is configured to receive at least one finger. By placing a finger in the recess, the operator can move the handle in both a forward direction and a rearward direction.

The present disclosure is further based in part on the realization that operators may desire to adjust a rotary position of the control lever unit, and thus a rotary position of the azimuth thruster, in a quick and easy manner, for example by using some fingers of the operator's hand only. Accordingly, herein it is suggested to include a pedestal placed below a main body of the control lever unit. In case the operator desires to adjust the rotary position of the azimuth thruster, the operator's hand can rest on a base plate of the control lever unit, and the rotary position can be adjusted with the fingertips contacting the pedestal.

The present disclosure is further based in part on the realization that the control lever unit can be equipped with a button configured as a safety button to prevent an undesired movement of the handle from the zero position in the rearward direction.

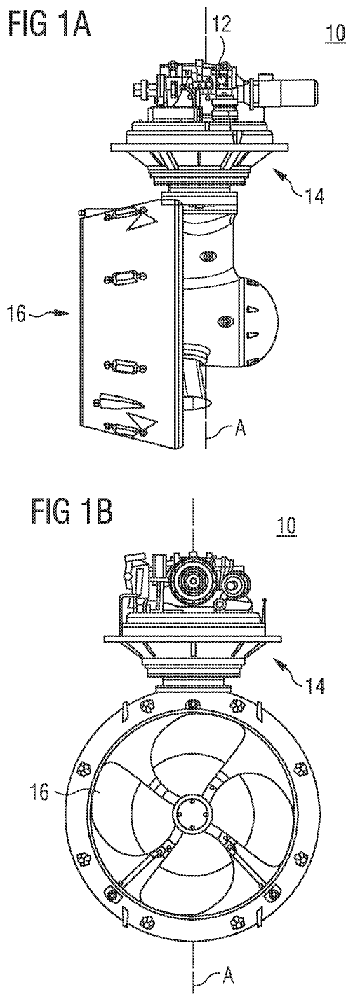

FIGS. 1A and 1B show an exemplary azimuth thruster 10. The azimuth thruster 10 can be controlled by the control lever unit according to the present disclosure.

The azimuth thruster 10 includes a drive unit 12, an azimuth unit 14, and a rotatable propeller 16. The drive unit 12 is operatively connected to the propeller 16 for rotating the propeller 16. For example, the propeller 16 may be a fixed pitch propeller or a variable pitch propeller. The azimuth unit 14 is configured to rotate the propeller 16 about a longitudinal axis A of the azimuth thruster 10 for maneuvering the vessel if desired.

The control lever unit according to the present disclosure is configured to control an azimuth thruster. Particularly, the control lever unit is configured to adjust a thrust force and thrust direction generated by the propeller 16 of the azimuth thruster 10. More particularly, the control lever unit is configured to adjust a speed of the propeller 16, a rotary position of the propeller 16 about the longitudinal axis A, a pitch angle of the propeller 16, and/or a clutch engagement state, the clutch being interconnected between the drive unit 12 and a drive shaft of the azimuth thruster 10.

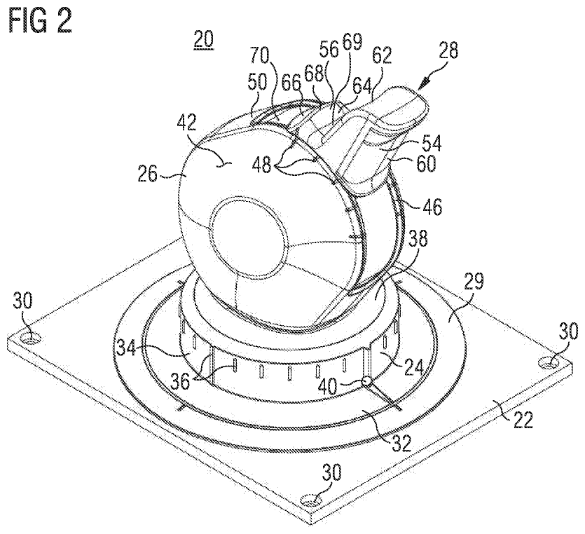

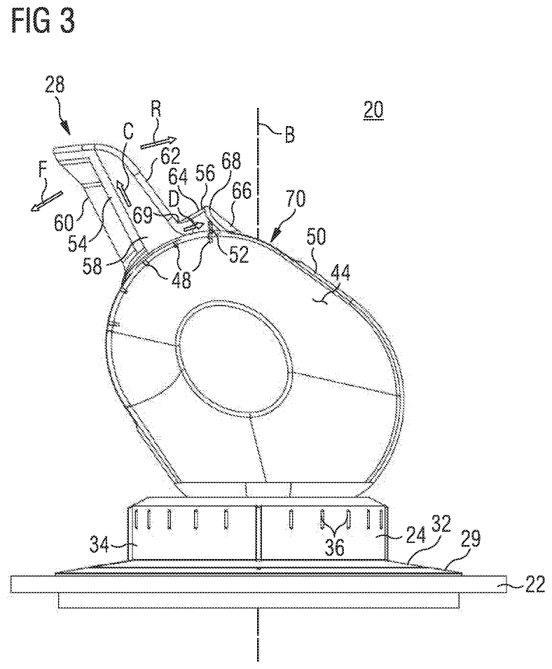

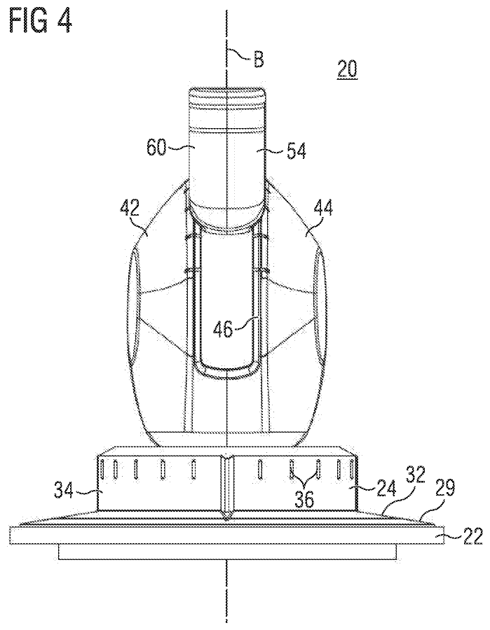

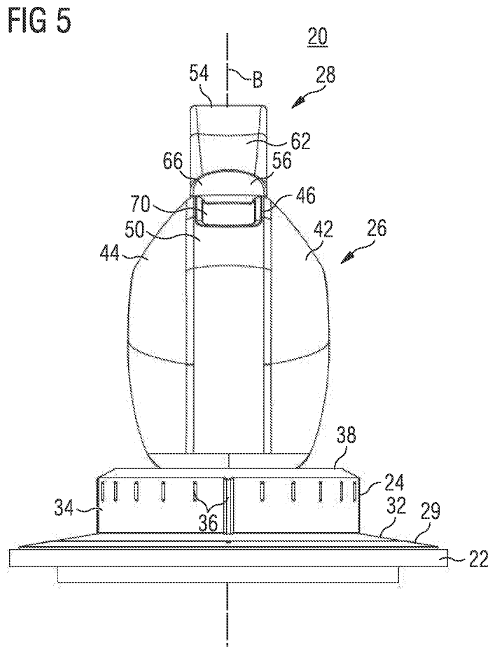

Referring to FIGS. 2 to 5, an exemplary control lever unit 20 is depicted in an isometric view (FIG. 2), in a side view (FIG. 3), in a front view (FIG. 4), and in a rear view (FIG. 5). In the following, the control lever unit 20 is described with reference to FIGS. 2 to 5.

The control lever unit 20 includes a base plate 22, a pedestal 24, a main body 26, and a handle 28. By turning the pedestal 24 and the main body 26 relative to the base plate 22, a rotary position of the azimuth thruster 10 (see FIGS. 1A and 1B) is adjustable. A forward and rearward thrust force of the azimuth thruster 10 (see FIGS. 1A and 1B) is adjustable by moving, particularly pivoting, the handle 28 relative to the main body 26.

The base plate 22 is mountable to a control panel on a bridge of a vessel including the azimuth thruster 10. For example, the base plate 22 includes a plurality of mounting holes 30 for inserting screws or the like. The base plate 22 includes an inner ring face 29 defining a central opening for receiving a bottom disc 32 connected below the pedestal 24. The inner ring face 29 may be provided with a scale or indications providing a reference for adjusting the rotary position of the azimuth thruster 10. The base plate 22 further defines a central axis B extending normal to the base plate 22. In other words, the central axis B extends perpendicular to a plane of the base plate 22. Particularly, the central axis B is a central axis of the central opening and the main body 26.

The pedestal 24 is rotatable about the central axis B relative to the base plate 22 for adjusting the rotary position of the azimuth thruster 10 about the longitudinal axis A (see FIGS. 1A and 1B). The pedestal 24 protrudes from the disc 32 in a direction of the central axis B away from the base plate 22. Similar to the inner ring face 29, the disc 32 may include a scale or indication(s) on a top face thereof. The pedestal 24 includes a circumferential face 34 extending about the central axis B. The circumferential face 34 extends parallel to the central axis B. The circumferential face 34 includes a plurality of indications 36, for example formed as protrusions or recesses, arranged at equal intervals about the central axis B. The pedestal 24 further includes a top face 38 on which the main body 26 is disposed. Specifically, the pedestal 24 is interconnected between the base plate 22 and the main body 26 with respect to the central axis B.

The pedestal 24 eases adjustments of the azimuth thruster 10 with respect to a rotary position of the azimuth thruster 10 about the longitudinal axis A. Particularly, in case an operator desires to adjust the rotary position of the azimuth thruster 10 only (without adjusting a thrust force), the operator's hand can rest on the base plate 22. The rotary position can be adjusted with the fingertips contacting the pedestal 24. The operator does not have to grip the entire main body 26 with his hand. Particularly, the protrusions and/or the recesses in the circumferential face 34 provide contact sections for the fingertips of the operator's hand. Moreover, since the circumferential face 34 extends parallel to the central axis B, slippage of the fingers may be prevented.

In some embodiments, the pedestal 24 may further include a light source 40. The light source 40 is configured to generate a light beam, and to direct the light beam onto the disc 32 and the inner ring face 29 of the base plate 22. The light source 40 may be a LED (light-emitting diode). Particularly, the light beam of the light source 40 provides a reference for a relative position between the pedestal 24 and the base plate 22 in dark environments, for example at night with no or very little artificial light on the bridge of the vessel.

The main body 26 is, together with the pedestal 24, rotatable about the central axis B relative to the base plate 22 for adjusting the rotary position of the azimuth thruster 10. The main body 26 extends from the top face 38 of the pedestal 24 in a direction of the central axis B away from the pedestal 24 and the base plate 22. The main body 26 is ergonomically designed to provide a contact area for a palm of an operator's hand. Particularly, the main body 26 includes two rounded side faces 42 and 44 oppositely directed to each other. In the shown embodiment, the first side face 42 is configured to receive a palm of a right hand of an operator, whereas the second side face 44 is configured to receive a palm of a left-hand of an operator. In the shown embodiment, the main body 26 is substantially egg-shaped. Alternatively, the main body 26 may include any other shape facilitating to grip the main body 26, and to rotate the main body 26 about the central axis B.

The main body 26 includes a handle guide 46 for guiding the handle 28. As shown in FIGS. 2 to 4, the handle guide 46 may include indications 48 shaped as protrusions and/or recesses to provide a visual and/or haptic reference for an operator adjusting the thrust force of the azimuth thruster 10 by adjusting a position of the handle 28 relative to the main body 26. The handle guide 46 longitudinally extends in a round or convex top face 50 of the main body 26. The top face 50 connects the first side face 42 and the second side face 44.

The handle 28 is movable in the handle guide 46 to adjust a forward or rearward thrust force of the azimuth thruster 10. Particularly, the handle 28 is pivotably connected to the main body 26. The handle 28 can be moved in a first or forward direction and a second or rearward direction as indicated in FIG. 3 by arrows F and R. Based on a starting position of the handle 28, an adjustment of the handle 28 in the forward direction F may either increase a forward thrust force of the azimuth thruster 10 or decrease a rearward thrust force of the azimuth thruster 10. Analogous, an adjustment of the handle 28 in the rearward direction R may either decrease the forward thrust force or increase a rearward thrust force. In other words, the handle 28 can be positioned in a zero position, in which the azimuth thruster 10 does not generate any thrust force. Adjusting the handle 28 from the zero position in the forward direction F increases the forward thrust force, and adjusting the handle 28 from the zero position in the rearward direction R increases the rearward thrust force. The zero position is an intermediate position between a first end position and an opposite second end position for moving the handle 28. For example, the first end position and the second end position may be defined by the handle guide 46. The zero position and further handle positions may be indicated by the indications 48. For providing a reference to the indications 48, the handle 28 may also include an indication 52, for example formed as an elongate protrusion or recess.

The handle 28 includes a first handle portion 54 and a second handle portion 56. The second handle portion 56 is configured as a tail end portion of the handle 28. The first handle portion 54 extends in one direction C (see FIG. 3) away from the main body 26. The second handle portion 56 is connected to the first handle portion 54. The second handle portion 56 extends as a protrusion from a base section 58 of the first handle portion 54 in another direction D (see FIG. 3) from the first handle portion 54. The other direction D intersects the one direction C. Particularly, the other direction D is perpendicular to the one direction C. The first handle portion 54 and the second handle portion 56 together form an “L”-shape as can be seen in the side view of FIG. 3. The first handle portion 54 substantially has an I-shape. The second handle portion 56 is substantially formed as a triangular prism.

The first handle portion 54 includes a first contact face 60 and a second contact face 62. The first and second contact faces 60, 62 are disposed on opposite sides of the first handle portion 54. Specifically, the first contact face 60 of the first handle portion 54 is directed in the forward direction F, and the second contact face 62 of the first handle portion 54 is directed in the rearward direction R. The second handle portion 56 also includes a first contact face 64 and a second contact face 66. The first and second contact faces 64, 66 of the second handle portion 56 are disposed on opposite sides of the second handle portion 56. Similar to the first and second contact faces 60, 62 of the first handle portion 54, the first and second contact faces 64 and 66 of the second handle portion 56 are directed in the forward and rearward directions F and R, respectively. The first and second contact faces 64, 66 together form a protrusion 68 of the second handle portion 56 extending away from the main body 26. The first contact face 64 of the second handle portion 56 smoothly transitions into the second contact face 62 of the first handle portion 54 via a radius. Particularly, a recess 69 of the handle 28 is formed by the first contact face 64 of the second handle portion 56 and the second contact face 62 of the first handle portion 54. The recess 69 is configured to receive one or more fingers of the operator's hand for moving the handle 28. The recess 69 extends in a horizontal direction substantially perpendicular to the forward and rearward directions.

The first contact face 64 of the second handle portion 56 and the second contact face 62 of the first handle portion 54 may confine an acute angle (an angle smaller than 180°), for example about 90° as exemplary illustrated in FIG. 3.

By providing the first and second handle portions 54 and 56, the handle 28 itself can be used as a suitable visual and haptic indication of the rotary position of the azimuth thruster 10. By providing the first and second handle portions 54 and 56, the handle 28 is substantially not formed as a body of revolution. In contrast, a handle (substantially) formed as a body of revolution cannot be used by an operator for providing information on the rotary position of the azimuth thruster.

Additionally, the handle 28 particularly provides two contact faces for the operator's hand for moving the handle 28 in the forward direction F. The operator may either push against the second contact faces 66 of the second handle portion 56 with one or more of his fingers, or may push against the second contact face 62 of the first handle portion 54 with one or more of his fingers. Similarly, the handle 28 provides two contact faces for the operator's hand for moving the handle 28 in the rearward direction R. Specifically, the operator may either push against the first contact face 64 of the second handle portion 56 or the first contact face 60 of the first handle portion 54. More particularly, the operator may place one or more fingers, for example a thumb, in the recess 69 formed by the first contact face 64 of the first handle portion 56 and the second contact face 62 of the first handle portion 54. This allows to easily move the handle 28 with one finger only in the forward and rearward directions F, R.

In some embodiments, the control lever unit 20 further comprises a button 70. The button 70 is configured as a safety button to prevent an undesired movement of the handle 28 from the zero position in the rearward direction R. For example, it may happen that an operator wants to decelerate the azimuth thruster 10 to zero thrust. The operator pushes the handle 28 into the zero position. The button 70 prevents that the operator pushes the handle 28 to far, in other words, beyond the zero position in the rearward direction R. The operator does not unintentionally actuate the azimuth thruster 10 to provide a rearward thrust force. In situations, in which a rearward thrust is desired, the operator pushes the button 70 to move the handle 28 beyond the zero position in the rearward direction R.

Specifically, the button 70 is movable between a first button position as shown in FIG. 2, and a second button position. The button 70 is movable into the second button position against a biasing force urging the button 70 into the first button position. The biasing force may be provided by a biasing mechanism not shown in further detail, for example a spring. The first button position is the resting position of the button 70. In the first button position, the handle 28 is free to move between the first end position and the zero position (intermediate position between the first and second end positions). Additionally, in the first button position, the handle 28 is locked from moving between the zero position and the second end position. In the second button position, the handle 28 is free to move between the first end position and the second end position which includes movements beyond the zero position in the rearward direction R.

The button 70 is configured to mechanically lock the handle 28 from moving between the zero position and the second end position in the first button position. In other embodiments, any other mechanism for locking the handle 28 based on a position of the button 70 may be used.

In the shown embodiment, the button 70 is disposed in the handle guide 46. The button 70 can be pushed from the first button position to the second button position. Thereby, the button 70 is lowered into the handle guide 46 and does no longer block a movement of the handle 28 from the zero position to the second end position. In the second button position of the button 70, the handle 28, particularly the second handle portion 56, can slide over the lowered button 70 when moving from the zero position in the rearward direction R. The button 70 is hold down by the second handle portion 56 as long as the handle 28 is moved between the zero position and the second end position. As soon as the handle 28 is moved to the zero position again, the second handle portion 56 no longer holds down the button 70. The button 70 returns to the first button position under the influence of the biasing mechanism, and thus blocks movement of the handle 28 from the zero position to the second end position again.

The control lever unit 20 may further include electronics (not shown in the Figs.) configured to detect a position of the handle 28 relative to the main body 26, and to detect a rotary position of the pedestal 24 (the main body 26) relative to the base plate 22. The electronics are further configured to output signals indicating said positions of the handle 28 and the pedestal 24 (the main body 26) to a control unit of the azimuth thruster 10. For example, the electronics may be accommodated in the main body 26 and/or the pedestal 24, and/or may extend below the base plate 22 in a direction of the central axis B.

It is noted that a control lever according to the present disclosure does not necessarily has to include all features of the exemplary control lever unit 20 as described herein. In particular, in one aspect, the control lever unit may particularly include the pedestal 24 and, in exemplary embodiments thereof, the features relating to the pedestal 24. In another aspect, the control lever unit may particularly include the button 70 and, in exemplary embodiments thereof, features relating to the button 70.

### INDUSTRIAL APPLICABILITY

The control lever unit as disclosed herein is applicable in vessels using an azimuth thruster. The control lever unit can be used to control operation of the azimuth thruster, for example adjusting a speed, a rotary position, a pitch angle, etc. of the azimuth thruster.

Terms such as “about”, “around”, “approximately”, or “substantially” as used herein when referring to a measurable value such as a parameter, an amount, a temporal duration, and the like, is meant to encompass variations of ±10% or less, preferably ±5% or less, more preferably ±1% or less, and still more preferably ±0.1% or less of and from the specified value, insofar as such variations are appropriate to perform in the disclosed invention. It is to be understood that the value to which the modifier “about” refers is itself also specifically, and preferably, disclosed.

It is explicitly stated that all features disclosed in the description and/or the claims are intended to be disclosed separately and independently from each other for the purpose of original disclosure as well as for the purpose of restricting the claimed invention independent of the composition of the features in the embodiments and/or the claims. It is explicitly stated that all value ranges or indications of groups of entities disclose every possible intermediate value or intermediate entity for the purpose of original disclosure as well as for the purpose of restricting the claimed invention, in particular as limits of value ranges.

Although the preferred embodiments of this invention have been described herein, improvements and modifications may be incorporated without departing from the scope of the following claims.

1. A control lever unit for an azimuth thruster, comprising:
a base plate defining a central axis normal to the base plate;
a main body rotatably connected to the base plate to be rotatable relative to the base plate about the central axis;
a handle movably connected to the main body, the handle including:
a first handle portion extending away from the main body; and
a second handle portion extending as a protrusion away from the first handle portion.

2. The control lever unit of claim 1, wherein:
the first handle portion extends from a base section of the first handle portion away from the main body; and
the second handle portion extends from the base section of the first handle portion.

3. The control lever unit of claim 2, wherein the handle includes a recess formed by the first handle portion and the second handle portion.

4. The control lever unit of claim 3, wherein the recess is configured to receive at least one finger for moving the handle.

5. The control lever unit of claim 4, wherein:
the first handle portion and the second handle portion together substantially form an L-shape; and/or
the second handle portion smoothly transitions into the first handle portion.

6. The control lever unit of claim 5, wherein:
the second handle portion includes a protrusion extending in a direction away from the main body; and/or
the second handle portion is substantially formed as a triangular prism.

7. The control lever unit of claim 6, wherein:
the first handle portion includes:
a first contact face for pushing the handle in a first direction, and
a second contact face for pushing the handle in a second direction opposite the first direction; and/or
the second handle portion includes:
a first contact face for pushing the handle in the first direction, and
a second contact face for pushing the handle in the second direction.

8. The control lever unit of claim 7, further comprising a pedestal interconnected between the main body and the base plate to be rotatable together with the main body about the central axis relative to the base plate.

9. The control lever unit of claim 8, wherein the pedestal includes:
a circumferential face extending about the central axis; and/or
a light source configured to generate a light beam.

10. The control lever unit of claim 9, wherein:
the circumferential face has a plurality of indications, for example recesses and/or protrusions, arranged about the circumferential face of the pedestal; and/or
the circumferential face extends parallel to the central axis.

11. The control lever unit of claim 10, wherein the handle is movable from a first end handle position through an intermediate handle position to a second end handle position, the control lever unit further comprises a button being movable between a first button position and a second button position, wherein:
in the first button position, the handle is free to move between the first end handle position and the intermediate handle position and locked from moving between the intermediate handle position and the second end handle position, and
in the second button position, the handle is free to move at least between the intermediate handle position and the second end handle position.

12. The control lever unit of claim 11, wherein:
the button mechanically locks the handle from moving between the intermediate handle position and the second end handle position in the first button position; and/or
the button is biased in the first button position.

13. The control lever unit of claim 12, wherein the main body includes a handle guide configured to receive the handle for guiding the handle, and the button is disposed in the handle guide.

14. The control lever unit of claim 13, wherein the button blocks the handle from moving between the intermediate handle position and the second end handle position in the first button position, and enables the handle to move between the intermediate handle position and the second end handle position in the second button position.

15. The control lever unit of claim 14, wherein the handle is configured to slide over the button in the second button position.
